(19) United States
(12) Patent Application Publication
(10) Pub. No.: US 2016/0322620 A1
(43) Pub. Date: Nov. 3, 2016

(54) SEPARATOR FOR RECHARGEABLE LITHIUM BATTERY AND RECHARGEABLE LITHIUM BATTERY INCLUDING THE SAME

(71) Applicants: SAMSUNG SDI CO., LTD., Yongin-si (KR); SAMSUNG ELECTRONICS CO., LTD., Suwon-si (KR)

(72) Inventors: Hana KIM, Suwon-si (KR); Hyoungwoo CHOI, Hwaseong-si (KR); Jungsue JANG, Suwon-si (KR); Minho CHO, Suwon-si (KR); Myungkook PARK, Suwon-si (KR); Seungrim YANG, Seongnam-si (KR); Byungmin LEE, Suwon-si (KR); Eon-Mi LEE, Yongin-si (KR); Bo Kyung JUNG, Yongin-si (KR); Sung Soo HAN, Hwaseong-si (KR)

(21) Appl. No.: 15/139,700

(22) Filed: Apr. 27, 2016

(30) Foreign Application Priority Data
Apr. 28, 2015 (KR) 10-2015-0059999

(51) Int. Cl. H01M 2/16; H01M 10/0525

(52) U.S. Cl. CPC H01M 2/166; H01M 2/1686; H01M 10/0525

(57) ABSTRACT

A separator for a rechargeable lithium battery and a rechargeable lithium battery including the separator, the separator including a substrate, and a heat-resistant porous layer on at least one side of the substrate, the heat-resistant porous layer including a composite particle, wherein the composite particle includes a first particle and a second particle attached to a surface of the first particle, and the first particle is different from the second particle, and at least one of the first particle and the second particle includes an organic material.

### CROSS-REFERENCE TO RELATED APPLICATION

Korean Patent Application No. 10-2015-0059999, filed on Apr. 28, 2015, in the Korean Intellectual Property Office, and entitled: “Separator for Rechargeable Lithium Battery and Rechargeable Lithium Battery Including the Same,” is incorporated by reference herein in its entirety.

### BACKGROUND

1. Field

Embodiments relate to a separator for a rechargeable lithium battery and a rechargeable lithium battery including the same.

2. Description of the Related Art

Research on a rechargeable lithium battery has been actively made, as a battery having high energy density as a power source for a portable electronic device is desired. In addition, an electric vehicle and the like is researched with an increasing interest in the environment, and research on the rechargeable lithium battery as a power source for the electric vehicle has been actively made.

A rechargeable lithium battery may include a positive electrode, a negative electrode, and a separator interposed between the positive and the negative electrodes. The separator plays a role of electrically insulating the positive and negative electrodes, and may include micropores through which lithium ions are transferred.

### SUMMARY

Embodiments are directed to a separator for a rechargeable lithium battery and a rechargeable lithium battery including the same.

The embodiments may be realized by providing a separator for a rechargeable lithium battery, the separator including a substrate, and a heat-resistant porous layer on at least one side of the substrate, the heat-resistant porous layer including a composite particle, wherein the composite particle includes a first particle and a second particle attached to a surface of the first particle, and the first particle is different from the second particle, and at least one of the first particle and the second particle includes an organic material.

In the composite particle, the second particle may completely cover a surface of the first particle.

In the composite particle, the second particle may be distributed in an island arrangement on a surface of the first particle.

In the composite particle, the second particle may be a secondary particle that is an agglomeration of primary particles.

The organic material may include a polymer having an initiation temperature of thermal decomposition of about 300° C. to about 600° C.

The organic material may include an imide-containing compound, an amide-containing compound, an acryl-containing compound, or a combination thereof.

The first particle may be an inorganic particle, and the second particle may be an organic particle that includes the organic material.

The organic particle may have an amorphous shape, a spherical shape, a plate shape, a linear shape, or a combination thereof.

The inorganic particle may include Al₂O₃, SiO₂, B₂O₃, Ga₂O₃, TiO₂, SnO₂, or a combination thereof.

A particle size of the inorganic particle may be about 10 nm to about 1,000 nm.

The composite particle may include about 50 wt % to about 90 wt % of the first particle and about 10 wt % to about 50 wt % of the second particle, based on a total weight of the composite particle.

The heat-resistant porous layer may further include a binder.

The binder may include a vinylidenefluoride-based polymer, polymethylmethacrylate, polyacrylonitrile, polyvinylpyrrolidone, polyvinylacetate, polyethylene-vinylacetate copolymer, polyethyleneoxide, cellulose acetate, cellulose acetate butyrate, cellulose acetate propionate, cyanoethylpullulan, cyanoethylpolyvinyl alcohol, cyanoethyl cellulose, cyanoethylsucrose, pullulan, carboxylmethyl cellulose, an acrylonitrile-styrene-butadiene copolymer, copolymers thereof, or a combination thereof

The composite particle may be included in an amount of about 50 wt % to about 99 wt %, based on a total weight of the composite particle and the binder.

A shrinkage ratio in a machine direction and a shrinkage ratio in a transverse direction for the machine direction of the separator may each be less than or equal to about 10%, according to Equation 1:

Shrinkage ratio (%)=[(L0−L1)/L0]×100 [Equation 1]

wherein, in Equation 1, L0 indicates an initial length of a separator and L1 indicates a length of a separator after being allowed to stand at 200° C. and for 10 minutes.

The embodiments may be realized by providing a rechargeable lithium battery including the separator according to an embodiment.

### BRIEF DESCRIPTION OF THE DRAWINGS

Features will be apparent to those of skill in the art by describing in detail exemplary embodiments with reference to the attached drawings in which:

FIG. 1 illustrates a cross-sectional view of a composite particle according to one embodiment.

FIG. 2 illustrates a cross-sectional view of a composite particle according to another embodiment.

FIG. 3 illustrates a cross-sectional view of a composite particle according to another embodiment.

FIG. 4 illustrates an exploded perspective view of a rechargeable lithium battery according to one embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, when a definition is not otherwise provided, the term “substituted” may refer to one substituted or replaced with a substituent selected from a halogen (e.g., F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C20 alkoxy group, a C1 to C20 heteroalkyl group, a C3 to C20 heteroarylalkyl group, a C3 to C20 cycloalkyl group, a C3 to C20 cycloalkenyl group, a C4 to C20 cycloalkynyl group, a C2 to C20 heterocycloalkyl group, and a combination thereof, instead of hydrogen of a compound.

As used herein, when a definition is not otherwise provided, the term ‘hetero’ may refer to one including 1 to 3 hetero atoms selected from N, O, S, and P.

Hereinafter, a separator for a rechargeable lithium battery according to one embodiment is described.

The separator for a rechargeable lithium battery according to the present embodiment may separate a negative electrode and a positive electrode and may provide a transporting passage for lithium ions. The separator may include a substrate and a heat-resistant porous layer on at least one side of the substrate.

The substrate may be porous due to pores. Lithium ions may be transferred through the pores. The substrate may include, e.g., polyolefin, polyester, polytetrafluoroethylene (PTFE), polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylene sulfide, polyethylenenaphthalene, a glass fiber, or a combination thereof. Examples of the polyolefin may include polyethylene, polypropylene, and the like, and examples of the polyester may include polyethyleneterephthalate, polybutyleneterephthalate, and the like. The substrate may be a non-woven fabric or a woven fabric. The substrate may have a single layer or multilayer structure. For example, the substrate may be a polyethylene single layer, a polypropylene single layer, a polyethylene/polypropylene double layer, a polypropylene/polyethylene/polypropylene triple layer, a polyethylene/polypropylene/polyethylene triple layer, and the like. A thickness of the substrate may be about 1 μm to about 40 μm, e.g., about 1 μm to about 30 μm, about 1 μm to about 20 μm, about 5 μm to about 20 μm, or about 5 μm to about 10 μm. When the thickness of the substrate is within the range, short-circuit between positive and negative electrodes may be prevented without increasing internal resistance of a battery.

The heat-resistant porous layer may be formed on one side or both sides of the substrate, and may include a composite particle.

The composite particle may include, e.g., a first particle and a second particle attached to surface of the first particle. In an implementation, the composite particle may have various structures, as long as the second particle is attached on the surface of the first particle. When a composite particle having the structure is used to form a heat-resistant porous layer, a composition for the heat-resistant porous layer may have excellent composition stability, and the separator having the heat-resistant porous layer may have excellent heat resistance. For example, cell performance may be improved by further preventing thermal shrinkage of a substrate and thus suppressing short-circuits between positive and negative electrodes and in addition, minimizing resistance of lithium ions.

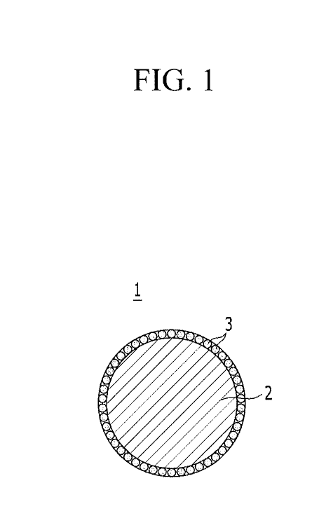

Hereinafter, the structures of the composite particle are described referring to FIGS. 1 to 3. FIGS. 1 to 3 illustrate examples of the structures of the composite particle.

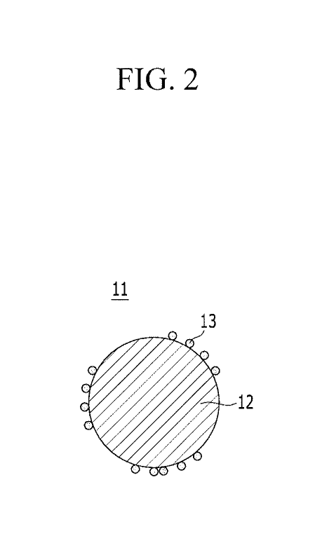

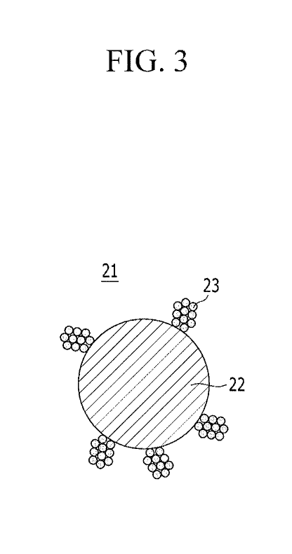

FIG. 1 illustrates a cross-sectional view of a composite particle according to one embodiment, FIG. 2 illustrates a cross-sectional view of a composite particle according to another embodiment, and FIG. 3 illustrates a cross-sectional view of a composite particle according to another embodiment.

Referring to FIG. 1, a composite particle 1 according to one embodiment may include a first particle 2, and a second particle 3 surrounding a surface of the first particle 2. For example, the second particle 3 may be attached to the surface of the first particle 2 due to a structure where the second particle 3 surrounds the surface of the first particle 2. In an implementation, the second particle 3 may completely surround the surface of the first particle 2 and thus form a core-shell structure. FIG. 1 shows that the second particle 3 is formed as a monolayer. In an implementation, the second particle 3 may be agglomerated to form a shell on the first particle 2.

Referring to FIG. 2, a composite particle 11 according to another embodiment may include a second particle 13 attached, e.g., partially attached, to a first particle 12 and on the surface of the first particle 12. For example, the second particle 13 may be discontinuously attached on or incompletely cover the surface of the first particle 12. For example, the second particle 13 may have an island arrangement on the surface of the first particle 12.

Referring to FIG. 3, a composite particle 21 according to still another embodiment may include a second particle 23 attached, e.g., partially attached, to a first particle 22 and on the surface of the first particle 22. For example, the second particle 23 may be a secondary particle formed by agglomerating primary particles. In an implementation, the second particle 23 (as the secondary particle) may be discontinuously attached on or may incompletely cover the surface of the first particle 22. For example, the second particle 23 (as the secondary particle of agglomerated primary particles) may have an island arrangement on the surface of the first particle 22.

The first particle and the second particle of the composite particle may be different. For example, the first particle and the second particle may be formed of different materials. In an implementation, at least one of the first particle and the second particle may include an organic material. In an implementation, the organic material may include a polymer having an initiation temperature of thermal decomposition of about 300° C. to about 600° C., e.g., about 400° C. to about 500° C. The initiation temperature of thermal decomposition may be measured by a thermogravimetric analyzer (TA instrument, Discovery TGA). For example, the initiation temperature of thermal decomposition may refer to a temperature at which thermal decomposition begins. When the organic material has an initiation temperature of thermal decomposition within the range, a separator having excellent heat resistance may secured. In an implementation, the organic material may form an organic composite with an organic binder, thus applying a bond between an inorganic particle and a separator. Accordingly, excellent composition stability and also strengthen a bonding force between the organic binder and the composite particle may be secure and heat resistance may be improved.

The organic material may include, e.g., an imide-based or imide-containing compound, an amide-based or amide-containing compound, an acryl-based or acryl-containing compound, or a combination thereof

The imide-containing compound may be a polymer having an imide bond, and the imide bond may have a linear or a ring shape such as heterocycle. For example, it may be a homopolymer having the same structural unit or a copolymer including repetitive different two or more structural units.

The imide-containing compound may be, e.g., an imide-containing polymer including a first structural unit represented by Chemical Formula 1, an imide-containing polymer including a second structural unit represented by Chemical Formula 2, or an imide-containing polymer including a first structural unit represented by Chemical Formula 1 and a second structural unit represented by Chemical Formula 2.

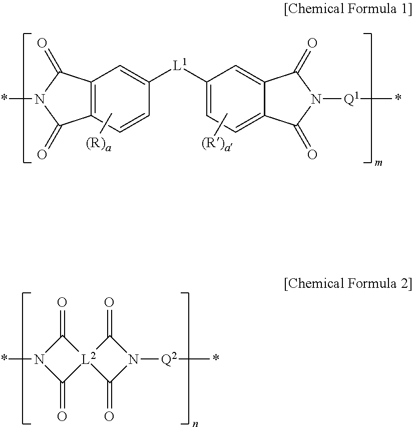

In Chemical Formulae 1 and 2,

L¹ may be, e.g., a C1 to C20 alkylene group, a C2 to C20 alkenylene group, a C2 to C20 alkynylene group, a C3 to C20 cycloalkylene group, a C3 to C20 cycloalkenylene group, a C4 to C20 cycloalkynylene group, or a C6 to C30 arylene group. In an implementation, at least one hydrogen of the alkylene group, the alkenylene group, the alkynylene group, the cycloalkylene group, the cycloalkenylene group, the cycloalkynylene group and/or the arylene group may be replaced with fluorine,

L² may be, e.g., a tetravalent aromatic group, a tetravalent aliphatic group, or a tetravalent alicyclic group. The aliphatic group and the alicyclic group may each independently include a linking group of —CO—, —O—, —SO₂—, or —S— in the moiety,

Q¹ and Q² may each independently be a divalent aromatic group,

R and R′ may each independently be a C1 to C20 alkyl group, a C2 to C20 alkenyl group, a C2 to C20 alkynyl group, a C3 to C20 cycloalkyl group, a C3 to C20 cycloalkenyl group, a C4 to C20 cycloalkynyl group, or a C6 to C30 aryl group,

a and a′ may each independently be an integer of 0 to 3,

m may be an integer of 1 to 1,000, and

n may be an integer of 1 to 2,000.

In an implementation, in Chemical Formula 1, L¹ may be, e.g., a C1 to C10 alkylene group substituted with at least one fluorine.

In an implementation, in Chemical Formula 2, L² may include a tetravalent linking group represented by one of the following Chemical Formulae 3-1 to 3-7.

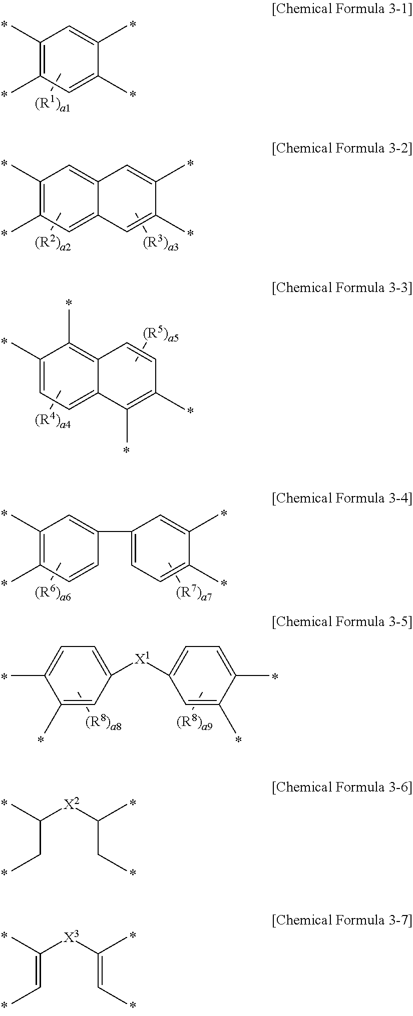

In Chemical Formulae 3-1 to 3-7,

X¹ to X³ may each independently be, e.g., a single bond, or a linking group of —CO—, —O—, —SO₂— or —S—,

R¹ to R⁹ may each independently be a C1 to C20 alkyl group, a C2 to C20 alkenyl group, a C2 to C20 alkynyl group, a C3 to C20 cycloalkyl group, a C3 to C20 cycloalkenyl group, a C4 to C20 cycloalkynyl group, or a C6 to C30 aryl group, and

a¹ to a⁹ may each independently be an integer of 0 to 3.

In Chemical Formulae 1 and 2, Q¹ and Q² may each independently include a divalent linking group represented by one of the following Chemical Formulae 4-1 to 4-3.

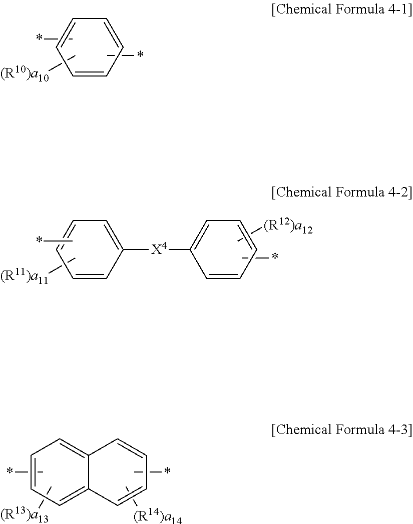

In Chemical Formulae 4-1 to 4-3,

X⁴ may be or may include, e.g., a single bond, —CO—, —O—, —SO₂—, —S—, a substituted or unsubstituted C1 to C20 alkylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C3 to C20 cycloalkenylene group, a substituted or unsubstituted C4 to C20 cycloalkynylene group, or a substituted or unsubstituted C6 to C30 arylene group,

R¹⁰ to R¹⁴ may each independently be a C1 to C20 alkyl group, a C2 to C20 alkenyl group, a C2 to C20 alkynyl group, a C3 to C20 cycloalkyl group, a C3 to C20 cycloalkenyl group, a C4 to C20 cycloalkynyl group, or a C6 to C30 aryl group, and

a¹⁰ to a¹⁴ may each independently be an integer of 0 to 4.

In an implementation, when the imide-containing compound is the imide-containing copolymer, the imide-containing copolymer may include about 10 mol % to about 90 mol % of the first structural unit and about 10 mol % to about 90 mol % of the second structural unit, e.g., about 30 mol % to about 90 mol % of the first structural unit and about 10 mol % to about 70 mol % of the second structural unit, about 40 mol % to about 90 mol % of the first structural unit and about 10 mol % to about 60 mol % of the second structural unit, or about 70 mol % to about 90 mol % of the first structural unit and about 10 mol % to about 30 mol % of the second structural unit. When the first structural unit and the second structural unit have a mole ratio within the range, composition stability may not only be improved during formation of a separator, but the separator may also have excellent heat resistance.

The amide-containing compound may be a polymer having an amide bond. For example, it may be a homopolymer having the same structural unit or a copolymer including repetitive different two or more structural units.

The amide-containing compound may be, e.g., an amide-based polymer including a structural unit represented by Chemical Formula 5.

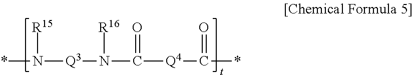

In Chemical Formula 5,

Q³ and Q⁴ may each independently be or include, e.g., a substituted or unsubstituted C1 to C20 alkylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C3 to C20 cycloalkenylene group, a substituted or unsubstituted C4 to C20 cycloalkynylene group, or a substituted or unsubstituted C6 to C30 arylene group,

R¹⁵ and R¹⁶ may each independently be independently hydrogen, a C1 to C20 alkyl group, a C2 to C20 alkenyl group, a C2 to C20 alkynyl group, a C3 to C20 cycloalkyl group, a C3 to C20 cycloalkenyl group, a C4 to C20 cycloalkynyl group, or a C6 to C30 aryl group, and

t may be an integer of 10 to 1,000.

In an implementation, in Chemical Formula 5, Q³ and Q⁴ may each independently be or include, e.g., a substituted or unsubstituted C6 to C30 arylene group.

In an implementation, the acryl-containing compound may be an acryl-containing polymer including a structural unit represented by Chemical Formula 6. In an implementation, the acryl-based compound may be a homopolymer having the same structural unit or a copolymer including repetitive different two or more structural units.

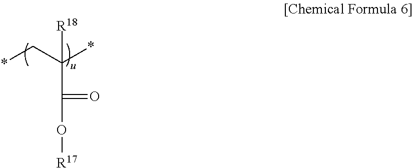

In Chemical Formula 6,

R¹⁷ may be or may include, e.g., hydrogen, a substituted or unsubstituted C1 to C20 alkyl group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C3 to C20 cycloalkenyl group, a substituted or unsubstituted C4 to C20 cycloalkynyl group, or a substituted or unsubstituted C6 to C30 aryl group,

R¹⁸ may be or may include, e.g., hydrogen or a substituted or unsubstituted C1 to C20 alkyl group, and

u may be an integer of 100 to 200,000.

In an implementation, the first particle of the composite particle may be an inorganic particle, and the second particle may be an organic particle. In an implementation, the inorganic particle may consist of or include an inorganic material singularly, and the organic particle may consist of or include an organic material, or a mixture of an organic material and an inorganic material. The organic material may be the same as described above.

In an implementation, the organic particle consisting of or including the organic material may have an amorphous shape, a spherical shape, a plate shape, a linear shape, or a combination thereof. The organic particle may consist of or include primary particles, a secondary particle formed by agglomeration of the primary particles, or a mixture of the primary particle and the secondary particle.

The inorganic particle consisting of or including the inorganic material may include, e.g., Al₂O₃, SiO₂, B₂O₃, Ga₂O₃, TiO₂, SnO₂, or a combination thereof. In an implementation, the inorganic particle may have a size (e.g., diameter) of about 10 nm to about 1,000 nm, e.g., about 300 nm to about 700 nm. In an implementation, more than two inorganic particles having a different particle diameter may be mixed. When the inorganic particle has a size within the range, a composition for a heat-resistant porous layer may be uniformly coated on a substrate, and a separator having excellent thermal stability as well as excellent composition stability may be secured. The size of the inorganic particle may be measured by a particle size analyzer.

The composite particle may include about 50 wt % to about 99 wt % of the first particle (e.g., the inorganic particle) and about 1 wt % to about 50 wt % of the second particle (e.g., the organic particle), e.g., about 70 wt % to about 99 wt % of the first particle and about 1 wt % to about 30 wt % of the second particle. When the composite particle has the composition range, thermal stability of a separator, as well as composition stability during a manufacture of a separator is improved.

In an implementation, the composite particle may have a size (e.g., diameter) of about 400 nm to about 1,500 nm, e.g., about 400 nm to about 1,000 nm. When the size of the composite particle is within the range, thermal stability of a separator as well as composition stability during a manufacture of a separator is improved. The size of the composite particle may be measured by a particle size analyzer.

The composite particle may be prepared by, e.g., simultaneously grinding the first particle and the second particle. The grinding may be performed by using, e.g., a bead mill, a ball mill, an ultrasonic wave, and the like.

In an implementation, the heat-resistant porous layer may have a thickness of about 0.01 μm to about 20 μm, e.g., about 1 μm to about 10 μm, or about 1 μm to about 5 μm. When the thickness of the heat-resistant porous layer is within the ranges, short-circuit inside a battery may be suppressed and a safe separator may be ensured due to improved heat resistance. In addition, an increase of internal resistance of a battery may be suppressed.

Hereinafter, a separator for a rechargeable lithium battery according to another embodiment is described.

A separator for a rechargeable lithium battery according to the present embodiment may include a substrate and a heat-resistant porous layer on at least one side of the substrate. In an implementation, the heat-resistant porous layer may include a filler and a binder. For example, the filler may be or may include the composite particle. The separator according to the present embodiment may include the binder unlike the separator according to the aforementioned embodiment even though the other constituent elements are substantially the same, and the binder will be mainly described herein.

The binder may be a compound different form the organic material in the composite particle. In an implementation, the binder may include, e.g., a vinylidene fluoride-based polymer, polymethylmethacrylate, polyacrylonitrile, polyvinylpyrrolidone, polyvinylacetate, a polyethylene-vinylacetate copolymer, polyethyleneoxide, cellulose acetate, cellulose acetate butyrate, cellulose acetate propionate, cyanoethyl pullulan, cyanoethylpolyvinyl alcohol, cyanoethyl cellulose, cyanoethylsucrose, pullulan, carboxylmethyl cellulose, an acrylonitrile-styrene-butadiene copolymer, their copolymers, or a combination thereof.

The vinylidene fluoride-based polymer may be a homopolymer including only a vinylidene fluoride monomer-derived unit, or a copolymer including a vinylidene fluoride-derived unit and other monomer-derived units. The copolymer may include, e.g., vinylidene fluoride-derived unit and at least one unit derived from chlorotrifluoroethylene (CTFE), trifluoroethylene (TFE), hexafluoropropylene (HFP), ethylene tetrafluoride, and an ethylene monomer. The copolymer may be a polyvinylidene fluoride-hexafluoropropylene (PVdF-HFP) copolymer including a vinylidene fluoride monomer-derived unit and a hexafluoropropylene (HFP) monomer-derived unit.

For example, the binder may include a polyvinylidene fluoride homopolymer, a polyvinylidene fluoride-hexafluoropropylene copolymer, or a combination thereof. When the binder includes the polyvinylidene fluoride homopolymer, the polyvinylidene fluoride-hexafluoropropylene copolymer, or the combination thereof, and the composite particle, simultaneously, adherence to the substrate may be further improved and a uniform heat-resistant porous layer may be provided. Therefore, a more stable separator may be ensured. In addition, impregnation properties of an electrolyte solution may be improved and thus high-rate charge and discharge characteristics of a battery may be improved.

The vinylidene fluoride-based polymer may have a weight average molecular weight of about 300,000 g/mol to about 1,700,000 g/mol, e.g., about 400,000 g/mol to about 1,500,000 g/mol. When the weight average molecular weight of the vinylidene fluoride-based polymer is within the ranges, adherence of the substrate and the heat-resistant porous layer may be fortified and adherence to an electrode may be also improved. In addition, the vinylidene fluoride-based polymer may also be well dissolved in a small amount of a solvent during formation of a heat-resistant porous layer. Accordingly, drying of the heat-resistant porous layer may be facilitated, a thermal shrinkage of a substrate may be suppressed, and a short-circuit between positive and negative electrodes may be prevented. In addition, excellent impregnation properties in an electrolyte solution may be obtained and thus cycle-life characteristics and high rate charge and discharge characteristics of a rechargeable lithium battery may be improved.

In an implementation, the polyvinylidene fluoride-hexafluoropropylene copolymer may include about 0.1 wt % to about 40 wt %, e.g., about 1 wt % to about 20 wt % of a repeating unit derived from hexafluoropropylene, based on the total weight of a repeating unit derived from vinylidene fluoride and a repeating unit derived from hexafluoropropylene.

In an implementation, the composite particle may be included in an amount of about 50 wt % to about 99 wt %, e.g., about 70 wt % to about 99 wt %, or about 80 wt % to about 95 wt %, based on a total weight of the composite particle and the binder. When the composite particle is included within the amount range, composition stability during formation of a separator as well as heat resistance is improved and adherence to the substrate may be fortified, and thus a more stable separator may be ensured.

In an implementation, a shrinkage ratio in each of a machine direction and a transverse direction (relative to the machine direction) of the separator may be less than or equal to about 10%, e.g., less than or equal to about 5%, or about 1% to about 5%, as calculated according to Equation 1. Accordingly, a stable rechargeable lithium battery during battery explosion and overheating may be realized.

Shrinkage ratio (%)=[(L0−L1)/L0]×100 [Equation 1]

In Equation 1, L0 indicates an initial length of a separator and L1 indicates a length of a separator after being allowed to stand at 200° C. and for 10 minutes.

Hereinafter, a separator for a rechargeable lithium battery according to another embodiment is described.

The heat-resistant porous layer may be formed by coating a coating composition including the, e.g., organic/inorganic, composite particle and a solvent on at least one of the substrate followed by drying the same. The coating composition may further include the binder. The solvent may include, e.g., alcohols such as methanol, ethanol, and isopropyl alcohol; or ketones such as acetone.

The solvent may be classified into a low boiling point solvent and a high boiling point solvent. The low boiling point solvent may have a boiling point of less than or equal to about 90° C., and the high boiling point solvent may have a boiling point of greater than about 90° C. For example, the low boiling point solvent may include alcohols such as methanol, ethanol, isopropyl alcohol, and the like; ketones such as acetone and the like, and the high boiling point solvent may include N-methylpyrrolidone (NMP), dimethyl acetamide (DMAc), and the like.

According to one embodiment, the solvent used to form the heat-resistant porous layer of a separator may be mainly the low boiling point solvent, e.g., in an amount of greater than or equal to about 85 wt % based on the total amount of the solvent. The low boiling point solvent may have large volatility and may be dried at a relatively low temperature and thus may do less damage on a substrate and may be even more efficiently dried. On the other hand, if the high boiling point solvent were to be mainly used, the solvent may not be easily volatilized, and could remain in a heat-resistant porous layer and thus could have an influence on deteriorating properties such as heat resistance and the like.

Accordingly, the organic material, e.g., the organic material including both structural units of Chemical Formulae 1 and 2, of the composite particle may help secure a separator having excellent properties such as heat resistance and the like as well as excellent solubility in the low boiling point solvent. For example, excellent solubility in the low boiling point solvent means that a precipitate is not produced, even though 85 wt % of the low boiling point solvent such as acetone and the like based on the total amount of the solvents is added to the high boiling point solvent such as NMP and the like after the imide-containing copolymer is dissolved in the high boiling point solvent.

In an implementation, the coating composition may be obtained by mixing about 1 wt % to about 30 wt % of the composite particle and the solvent as a balance and stirring the mixture at about 10° C. to about 40° C. for about 30 minutes to about 5 hours. The stirring may be performed with a ball mill, a bead mill, a screw mixer, and the like.

In an implementation, the coating composition may be coated on the substrate using a method of dip coating, die coating, roll coating, comma coating, and the like.

The drying may be performed through drying with warm air, hot air, or low humid air, vacuum-drying, or radiation of a far-infrared ray, an electron beam, and the like. The drying may be performed at about 60° C. to about 120° C. When the drying is performed within the temperature range, a heat-resistant porous layer having a smooth surface may be formed, even though the drying is not performed for a long time.

In an implementation, the heat-resistant porous layer may be formed on a substrate in a method of lamination, coextrusion, and the like in addition to the coating of the coating composition.

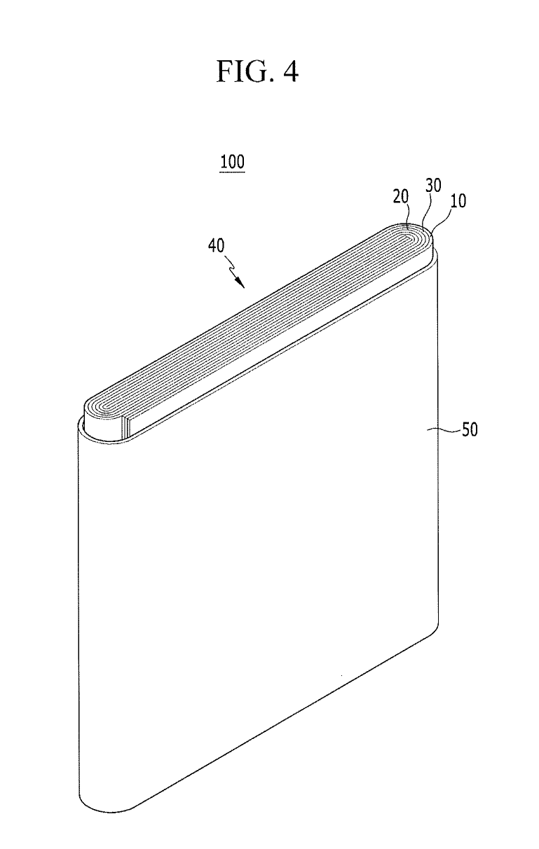

Hereinafter, a rechargeable lithium battery including the separator is described referring to FIG. 4.

FIG. 4 illustrates an exploded perspective view of a rechargeable lithium battery according to one embodiment. In an implementation, the battery according to an embodiment may be a prismatic rechargeable lithium battery. In an implementation, the battery may be, e.g., a lithium polymer battery or a cylindrical battery.

Referring to FIG. 4, a rechargeable lithium battery 100 according to one embodiment may include an electrode assembly 40 including a separator 30 interposed between a positive electrode 10 and a negative electrode 20, and a case 50 housing the electrode assembly 40. The positive electrode 10, the negative electrode 20, and the separator 30 may be impregnated in an electrolyte solution.

The separator 30 may be the same as described above.

The positive electrode 10 may include a positive current collector and a positive active material layer on the positive current collector. The positive active material layer may include, e.g., a positive active material, a binder, and optionally a conductive material.

The positive current collector may use or include, e.g., aluminum (Al), nickel (Ni), and the like.

The positive active material may use or include a compound being capable of intercalating and deintercallating lithium. For example, at least one of a composite oxide or a composite phosphate of a metal selected from cobalt, manganese, nickel, aluminum, iron, or a combination thereof and lithium may be used. In an implementation, the positive active material may use lithium cobalt oxide, lithium nickel oxide, lithium manganese oxide, lithium nickel cobalt manganese oxide, lithium nickel cobalt aluminum oxide, lithium iron phosphate, or a combination thereof.

The binder may help improve binding properties of positive active material particles with one another and with a current collector. Examples may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like. These may be used singularly or as a mixture of two or more.

The conductive material may help improve conductivity of an electrode. Examples thereof may include natural graphite, artificial graphite, carbon black, a carbon fiber, a metal powder, a metal fiber, and the like. These may be used singularly or as a mixture of two or more. The metal powder and the metal fiber may use a metal of copper, nickel, aluminum, silver, and the like.

The negative electrode 20 may include, e.g., a negative current collector and a negative active material layer formed on the negative current collector.

The negative current collector may use or include, e.g., copper (Cu), gold (Au), nickel (Ni), a copper alloy, and the like.

The negative active material layer may include, e.g., a negative active material, a binder, and optionally a conductive material.

The negative active material may be, e.g., a material that reversibly intercalates/deintercalates lithium ions, a lithium metal, a lithium metal alloy, a material being capable of doping and dedoping lithium, a transition metal oxide, or a combination thereof

The material that reversibly intercalates/deintercalates lithium ions may be a carbon material which is a suitable carbon-based negative active material, and examples thereof may include crystalline carbon, amorphous carbon, or a combination thereof. Examples of the crystalline carbon may include graphite such as amorphous, plate-shape, flake, spherical shape or fiber-shaped natural graphite or artificial graphite. Examples of the amorphous carbon may include soft carbon (low temperature fired carbon) or hard carbon, a mesophase pitch carbonized product, fired coke, and the like. The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn. The material being capable of doping and dedoping lithium may be Si, SiOₓ (0<x<2), a Si—C composite, a Si—Y′ alloy, Sn, SnO₂, a Sn—C composite, a Sn—Y′, and the like, and at least one of these may be mixed with SiO₂. Examples of the element Y′ may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. The transition metal oxide may be vanadium oxide, lithium vanadium oxide, and the like.

The binder and the conductive material used in the negative electrode may be the same as the binder and conductive material of the positive electrode.

The positive electrode and the negative electrode may be manufactured by mixing each active material composition including each active material and a binder, and optionally a conductive material in a solvent, and coating the active material composition on each current collector. In an implementation, the solvent may include N-methylpyrrolidone or the like.

The electrolyte solution may include an organic solvent and a lithium salt.

The organic solvent serves as a medium for transmitting ions taking part in the electrochemical reaction of a battery. Examples thereof may include a carbonate-based solvent, an ester-based solvent, an ether-based solvent, a ketone-based solvent, an alcohol-based solvent, and an aprotic solvent.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. For example, when the linear carbonate compounds and cyclic carbonate compounds are mixed, an organic solvent having a high dielectric constant and a low viscosity may be provided. The cyclic carbonate compound and the linear carbonate compound may be mixed together in a volume ratio of about 1:1 to about 1:9.

Examples of the ester-based solvent may include methylacetate, ethylacetate, n-propylacetate, dimethylacetate, methylpropionate, ethylpropionate, γ-butyrolactone, decanolide, valerolactone, mevalonolactone, caprolactone, and the like. Examples of the ether-based solvent may include dibutylether, tetraglyme, diglyme, dimethoxyethane, 2-methyltetrahydrofuran, tetrahydrofuran, and the like. Examples of the ketone-based solvent may include cyclohexanone, and the like, and examples of the alcohol-based solvent may be ethanol, isopropyl alcohol, and the like.

The organic solvent may be used singularly or in a mixture of two or more, and when the organic solvent is used in a mixture of two or more, the mixture ratio may be controlled in accordance with a desirable cell performance.

The lithium salt may be dissolved in the organic solvent, may supply lithium ions in a battery, may basically operate the rechargeable lithium battery, and may help improve lithium ion transportation between positive and negative electrodes therein.

Examples of the lithium salt may include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂), in which x and y are natural numbers, LiCl, LiI, LiB(C₂O₄)₂, or a combination thereof

The lithium salt may be used in a concentration of about 0.1 M to about 2.0 M. When the lithium salt is included within the above concentration range, an electrolyte may have excellent performance and lithium ion mobility due to optimal electrolyte conductivity and viscosity.

A rechargeable lithium battery including the separator may realize high capacity without degradation of cycle-life characteristics.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Synthesis Example 1

### Synthesis of Amide-Based Polymer

75.1 g of meta-phenylene diamine (mPD) (SIGMA-ALDRICH) and 354 g of N-methyl-2-pyrrolidone (NMP) were put in a mechanical stirrer under a nitrogen stream and stirred until dissolved to prepare a first solution. In addition, 40.0 g of isophthaloyl chloride (IPC) (SIGMA-ALDRICH) and 300 g of N-methyl-2-pyrrolidone (NMP) were added thereto under a nitrogen stream to prepare a second solution. The first and second solutions were mixed and stirred at ambient temperature for 3 hours, and then, a product was precipitated with an excess of deionized water to remove a non reactant and a residual organic solvent, and treated under a reduced pressure and dried to synthesize an amide-containing polymer including a structural unit represented by Chemical Formula 7.

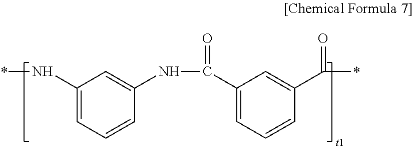

In Chemical Formula 7, t¹ is 250.

### Synthesis Example 2

### Synthesis of Imide-Based Copolymer

16.02 g of 4,4′-(hexafluoroisopropylidene)diphthalic anhydride (6FDA) (TOKYO CHEMICAL INDUSTRY), 0.9 g of pyromellitic dianhydride (PMDA) (TOKYO CHEMICAL INDUSTRY), and 50 g of N-methyl-2-pyrrolidone (NMP) were put in a mechanical stirrer under a nitrogen stream and stirred until dissolved to prepare a first solution. In addition, 10 g of methylene diphenyl diisocyanate (MDI) (TOKYO CHEMICAL INDUSTRY) and 50 g of N-methyl-2-pyrrolidone (NMP) were added thereto under a nitrogen stream until dissolved to prepare a second solution. The first and second solutions were mixed and stirred at 60° C. for 3 hours, and then, a product was precipitated with an excess of deionized water to remove a non reactant and a residual organic solvent and then, treated under a reduced pressure and dried to synthesize an imide-containing copolymer including a structural unit represented by Chemical Formula 8.

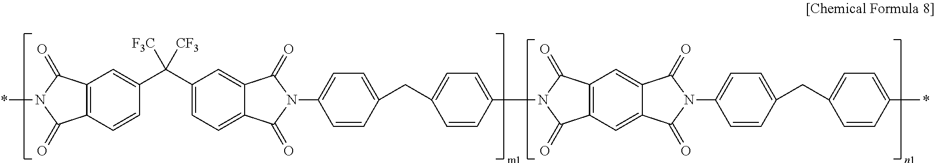

In Chemical Formula 8, m¹ is 126, n¹ is 14, and a mole ratio of m¹ and n¹ is 9:1.

### Manufacture of Separator

### Example 1

7 wt % of the amide-based polymer according to Synthesis Example 1 and 93 wt % of Al₂O₃ having a size (an average diameter) of about 450 nm based on a solid were simultaneously ground in acetone with a bead mill at 25° C. for 2 hours to obtain a composite particle dispersion liquid. The dispersion liquid consisted of 27 wt % of a composite particle and 73 wt % of the acetone. Herein, the composite particle had a structure that an amide-based polymer particles were attached on the surface of the Al₂O₃ having a size (an average diameter) of about 450 nm and a total particle size of about 530 nm when measured by a particle size analyzer.

In addition, 7 wt % of a polyvinylidene fluoride-hexafluoropropylene copolymer (KF 9300, KUREHA Corp.), 45 wt % of dimethyl acetamide, and 48 wt % of acetone were mixed in a stirrer at 40° C. for 4 hours to obtain a binder solution.

7.7 wt % of the binder solution, 53.5 wt % of the composite particle dispersion liquid, and 38.8 wt % of acetone were mixed to prepare slurry.

The slurry was dip-coated to be respectively 2 μm thick and thus, 4 μm thick in total on both sides of a 7 μm-thick polyethylene single-layered film and dried at 80° C. at an air flow speed of 10 m/s to manufacture a separator.

### Example 2

A separator was manufactured according to the same method as Example 1 except for using a composite particle dispersion liquid prepared as follows.

7 wt % of the imide-based copolymer according to Synthesis Example 2 and 93 wt % of Al₂O₃ having a size (an average diameter) of about 450 nm based on a solid were simultaneously ground with a bead mill at 25° C. for 2 hours to obtain a composite particle dispersion liquid. The dispersion liquid consisted of 27 wt % of a composite particle and 73 wt % of the acetone. Herein, the composite particle had a structure that imide-based copolymer particles were attached on the surface of the Al₂O₃ having a size of about 450 nm and a total size of about 530 nm measured by a particle size analyzer.

### Example 3

A separator was manufactured according to the same method as Example 1 except for preparing a binder solution by using cellulose triacetate (CTA) (Samsung Fine Chemicals Co., Ltd.) instead of the PVdF-HFP copolymer.

### Comparative Example 1

Al₂O₃ was ground with a bead mill at 25° C. for 2 hours to obtain an inorganic dispersion liquid including 25 wt % of the Al₂O₃ and 75 wt % of acetone. 19.5 wt % of the binder solution according to Example 1, 54.5 wt % of the inorganic dispersion liquid, and 26 wt % of acetone were mixed to prepare slurry.

Then, the slurry was used to manufacture a separator in the same method as Example 1.

### Comparative Example 2

Al₂O₃ was ground with a bead mill at 25° C. for 2 hours to prepare an inorganic dispersion liquid including 25 wt % of the Al₂O₃ and 75 wt % of acetone. In addition, the amide-based polymer particle according to Synthesis Example 1 was ground through a bead mill to prepare an organic dispersion liquid including 15 wt % of the amide-based polymer particle and 85 wt % of acetone. 5.7 wt % of the binder solution according to Example 1, 53.3 wt % of the inorganic dispersion liquid, 9.3 wt % of the organic dispersion liquid, and 31.7 wt % of acetone were mixed to prepare slurry.

The slurry was used to manufacture a separator in the same method as Example 1.

### Comparative Example 3

The amide-based polymer particle according to Synthesis Example 1 was ground through a bead mill to obtain an organic dispersion liquid consisting of 15 wt % of an amide-based polymer particle and 85 wt % of acetone. 14.3 wt % of the binder solution according to Example 1, 53.3 wt % of the organic dispersion liquid, and 32.4 wt % of acetone were mixed to prepare slurry.

Then, the slurry was used to manufacture a separator in the same method as Example 1.

### Manufacture of Rechargeable Lithium Battery Cell

LiCoO₂, polyvinylidene fluoride, and carbon black in a weight ratio of 96:2:2 were added to an N-methylpyrrolidone (NMP) solvent to prepare a slurry. The slurry was coated on an aluminum (Al) thin film and dried, manufacturing a positive electrode.

Graphite, polyvinylidene fluoride, and carbon black were added to water in a weight ratio of 98:1:1 in a N-methylpyrrolidone (NMP) solvent to prepare a slurry. The slurry was coated on a copper foil, dried, and compressed, to manufacture a negative electrode.

An electrolyte solution was prepared by mixing ethylene carbonate (EC), ethylmethyl carbonate (EMC), and diethyl carbonate (DEC) in a volume ratio of 3:5:2 to obtain a mixed solvent and preparing a 1.15 M LiPF₆ solution therewith.

The positive and negative electrodes, the electrolyte solution, and each separator Examples 1 to 3 and Comparative Examples 1 to 3 were used to manufacture rechargeable lithium battery cells.

Evaluation 1: Analysis of Size and Morphology of Composite Particle

A particle size analyzer (S3500, Microtrac) was used to analyze the size of the composite particle according to Example 1.

In addition, the peak of the amide-based polymer particle was dominant in the initial times but decreased as time went in a particle size analysis at the initial times and 30 minutes and one hour after milling.

Accordingly, the amide-based polymer particle turned out not to be present alone.

In addition, as a STEM-EDS (scanning transmission electron microscope-energy dispersive spectrometry) analysis result of the composite particle according to Example 1, an amide-based polymer component (C, N) was detected all over the alumina particle.

The results of the particle size analysis and the STEM-EDS exhibited that an organic particle and an inorganic particle were composited to form a composite particle and thus it was expected that an amide-based polymer particle was attached on the surface of an alumina particle.

Evaluation 2: Composition Stability

Composition stability of each slurry for a heat-resistant porous layer according to Examples 1 to 3 and Comparative Examples 1 to 3 was evaluated according to the following method, and the results are provided in Table 1.

10 g of each composition was put to a 20 ml vial (e.g., such that the composition had a height of about 27.0 mm in the vial). After 72 hours, the height of particles sunk at the bottom of the vial (lower) and the height of a transparent organic solvent layer on top of the vial (upper) were measured in mm. Herein, the heights were measured after 3 days to find a clear difference.

In Table 1, below, the lower height is the height of particles sunk down at the bottom (e.g., as measured from the bottom of the vial), and the upper height is the height of the organic solvent layer from the top of the vial (e.g., the distance from the top of the vial to the top of the organic solvent layer).

Evaluation 3: Air Permeation of Separator

Air permeation of each separator according to Examples 1 to 3 and Comparative Examples 1 to 3 was measured according to the following method, and the results are provided in Table 1.

Each separator was cut into a size of 10 cm×10 cm to prepare a sample, and an air permeation tester was used to measure how long it took for 100 cc of air to permeate or pass through the sample.

Evaluation 4: Heat Resistance of Separator

Heat resistance of the separators according to Examples 1 to 3 and Comparative Examples 1 to 3 was evaluated by measuring a shrinkage ratio by heat, and the results are provided in Table 1.

A sample was prepared by cutting each separator to a size of 10 cm×10 cm and allowing the samples to stand at 200° C. in a predetermined convection oven for 10 minutes. Shrinkage ratios of the sample about MD (a machine direction) and TD (a traverse direction) were respectively measured. The shrinkage ratios were calculated according to Equation 1.

Shrinkage ratio (%)=[(L0−L1)/L0]×100 [Equation 1]

In Equation 1, L0 indicates an initial length of the separator and L1 indicates a length of the separator after being allowed to stand at 200° C. for 10 minutes.

TABLE 1

| | | Height (mm) | Air | Shrinkage | |
|---|---|---|---|---|---|
| | | (lower/upper/total | permeation | ratio (%) | |
| | heat-resistant porous layer | composition) | (sec/100 cc) | MD | TD |
| Ex. 1 | binder(PVdF-HFP) + composite | 3.5/3.0/27.0 | 230 | 5 | 4 |
| | particle (amide-based polymer particle | | | | |
| | and Al₂O₃ particle) | | | | |
| Ex. 2 | binder(PVdF-HFP) + composite | 3.5/3.0/27.0 | 245 | 4 | 5 |
| | particle (imide-based copolymer | | | | |
| | particle and Al₂O₃ particle) | | | | |
| Ex. 3 | binder(CTA) + composite particle | 3.5/5.0/27.0 | 236 | 10 | 8 |
| | (amide-based polymer particle and | | | | |
| | Al₂O₃ particle) | | | | |
| Comp. | Binder (PVdF-HFP) + Al₂O₃ particle | 2.0/2.0/27.0 | 219 | 82 | 84 |
| Ex. 1 | | | | | |
| Comp. | Binder (PVdF-HFP) + amide-based | 6.0/21.0/27.0 | 275 | 5 | 5 |
| Ex. 2 | polymer particle + Al₂O₃ particle | | | | |
| Comp. | Binder (PVdF-HFP) + amide-based | 20.0/7.0/27.0 | 400 | 15 | 12 |
| Ex. 3 | polymer particle | | | | |

Referring to Table 1, the separators having a heat-resistant porous layer formed by using a composite particle of one embodiment according to Examples 1 to 3 showed excellent air permeation and heat resistance as well as excellent composition stability compared with the separators according to Comparative Examples 1 to 3. Accordingly, the separator may realize a stable rechargeable lithium battery during explosion and overheating.

By way of summation and review, a separator having excellent battery stability in the face of exothermicity may be desirable, as a battery tends to be lighter and down-sized and keeps requiring of high capacity as a power source having high power/large capacity for the electric vehicle. For this battery, a separator formed by coating a binder resin and a ceramic particle on a porous substrate could be used. Such a separator may be unable to secure suitable stability due to shrinkage that may occur overheating of the battery.

The embodiments may provide a separator for a rechargeable lithium battery having improved heat resistance as well as improved composition stability during formation of a separator.

The embodiments may provide a rechargeable lithium battery having improved stability and battery performance due to the separator.

A rechargeable lithium battery separator according to an embodiment may have improved stability and performance due to a separator having improved heat resistance as well as improved composition stability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

1, 11, 21: composite particle
2, 12, 22: first particle
3, 13, 23: second particle
100: rechargeable lithium battery
10: positive electrode
20: negative electrode
30: separator
40: electrode assembly
50: case

What is claimed is:

1. A separator for a rechargeable lithium battery, the separator comprising:
a substrate, and
a heat-resistant porous layer on at least one side of the substrate, the heat-resistant porous layer including a composite particle,
wherein:
the composite particle includes a first particle and a second particle attached to a surface of the first particle, and
the first particle is different from the second particle, and at least one of the first particle and the second particle includes an organic material.

2. The separator as claimed in claim 1, wherein, in the composite particle, the second particle completely covers a surface of the first particle.

3. The separator as claimed in claim 1, wherein, in the composite particle, the second particle is distributed in an island arrangement on a surface of the first particle.

4. The separator as claimed in claim 1, wherein, in the composite particle, the second particle is a secondary particle that is an agglomeration of primary particles.

5. The separator as claimed in claim 1, wherein the organic material includes a polymer having an initiation temperature of thermal decomposition of about 300° C. to about 600° C.

6. The separator as claimed in claim 1, wherein the organic material includes an imide-containing compound, an amide-containing compound, an acryl-containing compound, or a combination thereof.

7. The separator as claimed in claim 1, wherein:
the first particle is an inorganic particle, and
the second particle is an organic particle that includes the organic material.

8. The separator as claimed in claim 7, wherein the organic particle has an amorphous shape, a spherical shape, a plate shape, a linear shape, or a combination thereof.

9. The separator as claimed in claim 7, wherein the inorganic particle includes Al₂O₃, SiO₂, B₂O₃, Ga₂O₃, TiO₂, SnO₂, or a combination thereof.

10. The separator as claimed in claim 7, wherein a particle size of the inorganic particle is about 10 nm to about 1,000 nm.

11. The separator as claimed in claim 1, wherein the composite particle includes about 50 wt % to about 90 wt % of the first particle and about 10 wt % to about 50 wt % of the second particle, based on a total weight of the composite particle.

12. The separator as claimed in claim 1, wherein the heat-resistant porous layer further includes a binder.

13. The separator as claimed in claim 12, wherein the binder includes a vinylidenefluoride-based polymer, polymethylmethacrylate, polyacrylonitrile, polyvinylpyrrolidone, polyvinylacetate, polyethylene-vinylacetate copolymer, polyethyleneoxide, cellulose acetate, cellulose acetate butyrate, cellulose acetate propionate, cyanoethylpullulan, cyanoethylpolyvinyl alcohol, cyanoethyl cellulose, cyanoethylsucrose, pullulan, carboxylmethyl cellulose, an acrylonitrile-styrene-butadiene copolymer, copolymers thereof, or a combination thereof.

14. The separator as claimed in claim 12, wherein the composite particle is included in an amount of about 50 wt % to about 99 wt %, based on a total weight of the composite particle and the binder.

15. The separator as claimed in claim 1, wherein a shrinkage ratio in a machine direction and a shrinkage ratio in a transverse direction for the machine direction of the separator are each less than or equal to about 10%, according to Equation 1:
Shrinkage ratio (%)=[(L0−L1)/L0]×100 [Equation 1]
wherein, in Equation 1, L0 indicates an initial length of a separator and L1 indicates a length of a separator after being allowed to stand at 200° C. and for 10 minutes.

16. A rechargeable lithium battery comprising the separator as claimed in claim 1.
